(19) United States
(12) Patent Application Publication
(10) Pub. No.: US 2024/0267797 A1
(43) Pub. Date: Aug. 8, 2024

(54) PRE-TERMINATION HANDOVER IN EDGE PROCESSING

(71) Applicant: T-Mobile USA, Inc., Bellevue, WA (US)

(72) Inventors: George Jason Schnellbacher, Leawood, KS (US); Zheng Fang, McLean, VA (US)

(21) Appl. No.: 18/164,556

(22) Filed: Feb. 3, 2023

(51) Int. Cl. H04W 36/00; H04W 36/14; H04W 36/18; H04W 36/24; H04W 36/30; H04W 76/10; H04W 76/30

(52) U.S. Cl. CPC H04W 36/0011; H04W 36/008375; H04W 36/14; H04W 36/18; H04W 36/30; H04W 76/10; H04W 76/30

(57) ABSTRACT

Disclosed solutions for edge processing for a mobile device, such as an unmanned aerial vehicle (UAV) having a first and second cellular modems, include: determining that loss of a first connection between the first cellular modem and a first cell of a cellular network is imminent (e.g., within 500 milliseconds); determining that the mobile device is in range to connect to a second cell; based on at least determining that the mobile device is in range to connect to the second cell and that the loss of the first connection is imminent, initiating a second connection between the second cellular modem of the mobile device and the second cell; and based on at least determining that the second connection is complete, terminating the first connection. This permits use of the cellular connections for command and control of a UAV with minimal risk of disruption during handovers.

### BACKGROUND

Unmanned aerial vehicles (UAVs), also known as drones, are used for both recreation and functional tasks, such as infrastructure inspection. For example, a UAV with a camera may follow an electrical power transmission line, gas or oil pipeline, or water conveyance (e.g., a canal) for miles, in order to perform an inspection. In such scenarios, the radio frequency (RF) wireless link from a human-operated UAV controller to the UAV may be insufficient to enable the UAV to reliably receive command and control signals from the controller or to enable the controller to reliably receive the inspection video signals from the UAV.

Unfortunately, when using cellular connectivity for the control channel as a solution for the range problem, service interruption during a handover (or otherwise moving to a new cellular sector/tower connection) may interrupt control and/or introduce control channel latency. This is because a cellular handover may take up to 60 milliseconds (ms).

### SUMMARY

The following summary is provided to illustrate examples disclosed herein, but is not meant to limit all examples to any particular configuration or sequence of operations.

Disclosed solutions for edge processing for a mobile device, such as an unmanned aerial vehicle (UAV) having a first and second cellular modem provide for “make before break” handovers. Solutions include: determining that loss of a first connection between the first cellular modem and a first cell of a cellular network is imminent (e.g., within 500 milliseconds); determining that the mobile device is in range to connect to a second cell; based on at least determining that the mobile device is in range to connect to the second cell and that the loss of the first connection is imminent, initiating a second connection between the second cellular modem of the mobile device and the second cell; and based on at least determining that the second connection is complete, terminating the first connection. This permits use of the cellular connections for command and control of a UAV with minimal risk of disruption during handovers. In some examples, the first and second cellular modems are on the same cellular network, although in some examples, the first and second modems may use different cellular networks.

### BRIEF DESCRIPTION OF THE DRAWINGS

The disclosed examples are described below with reference to the accompanying drawing figures listed below, wherein:

FIG. 1 illustrates an exemplary architecture that advantageously provides for pre-termination handover, in order to minimize communication channel disruption;

FIG. 2 illustrates further detail for the UAV of FIG. 1;

FIG. 3 illustrates further detail for the various cells of FIG. 1;

FIG. 4 illustrates further detail for the cellular network of FIG. 1;

FIGS. 5A, 5B, and 6 illustrate flowcharts of exemplary operations associated with examples of the architecture of FIG. 1; and

FIG. 7 illustrates a block diagram of a computing device suitable for implementing various aspects of the disclosure.

Corresponding reference characters indicate corresponding parts throughout the drawings, where practical. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Disclosed solutions for edge processing for a mobile device, such as an unmanned aerial vehicle (UAV) having a first and second cellular modem, provide for “make before break” handovers. Solutions include: determining that loss of a first connection between the first cellular modem and a first cell of a cellular network is imminent (e.g., within 500 milliseconds); determining that the mobile device is in range to connect to a second cell; based on at least determining that the mobile device is in range to connect to the second cell and that the loss of the first connection is imminent, initiating a second connection between the second cellular modem of the mobile device and the second cell; and based on at least determining that the second connection is complete, terminating the first connection.

This permits use of the cellular connections for command and control of a UAV with minimal risk of disruption during handovers. In some examples, the first and second cellular modems are on the same cellular network, although in some examples, the first and second modems may use different cellular networks. It should be noted that a cell tower may support different cells in different sectors, such that a handoff between cells, as described herein, may refer to a handoff between cells of different sectors of the same tower.

As used herein, imminent means within 500 milliseconds (ms).

Aspects of the disclosure improve the speed and reliability of cellular communications used for edge processing, such as flight control of UAVs. This is accomplished using a “make-before-break” handoff scheme that employs at least two cellular modems in a mobile device. The scheme maintains a first connection between one modem and one cell until verifying that a second connection between a second modem in the mobile device has connected with a second (another different) cell. That is, terminating the first connection is based on at least determining that the second connection is complete.

A soft handover, which was available in third generation (3G) cellular code division multiple access (CDMA), is one in which the channel with the initially-connected cell is retained and used (for a while) in parallel while a new channel with a different cell is being established. This was possible with a single modem in 3G CDMA because adjacent cells used the same frequency. The cell differentiation was provided by the cells' differing codes.

With the advent of fourth generation (4G) cellular networks, however, soft handovers (and a variation, termed softer handover) were discontinued. This is because 4G uses orthogonal frequency division multiplexing (OFDM), which is a frequency division method. Adjacent cells in 4G use different frequencies. Thus, only hard handovers, in which the channel with the initially-connected cell is terminated before a new channel with a different cell is established, are available in 4G. A hard handover is “break-before-make”.

Fifth generation (5G) cellular networks also use OFDM and have the same limitations that have rendered soft handovers impractical since the cellular industry departed from the CDMA cellular modems of 3G. Significantly, cellular network operations are governed by Third Generation Partnership Project (3GPP) technical standards (TSs). Even if a more complex cellular modem, within a mobile device, is modified to theoretically be able to support soft handover in OFDM, because the cellular network is constrained to operate according to 3GPP TSs that do not support soft handover, soft handover remains unavailable to mobile devices in 5G. The disclosure herein provides a work-around that is compatible with current 3GPP TSs to provide an alternative “make-before-break” scheme.

In some examples, a UAV and UAV controller may be communicating directly, using a peer-to-peer (P2P) connection, for the command and control signals from the UAV controller to the UAV and video feed signals from the UAV to the UAV controller. Upon sensing that the direct P2P connection is about to be lost (e.g., the UAV has flown a certain distance away from the UAV controller), the UAV and UAV controller may use aspects of the disclosure to set up a new cellular connection prior to terminating the P2P connection. This way, the command and control signals from the UAV controller to the UAV are not interrupted while the first cellular network connection is being set up.

Although a leap-frog approach is described herein, in which the two cellular modems take turns connecting and disconnecting, such that one is always connected, it should be understood that, when one cellular modem makes a new connection, the other one may retain its connection. Although disconnecting a modem (when the other has connected) may be preferable for battery savings, it is not necessary. In some situations, a simultaneous connection scenario, that has both cellular modems active and available for data transfer, may be preferable. The different cellular modems may use different frequencies and/or be on different sectors during a simultaneous connection scenario.

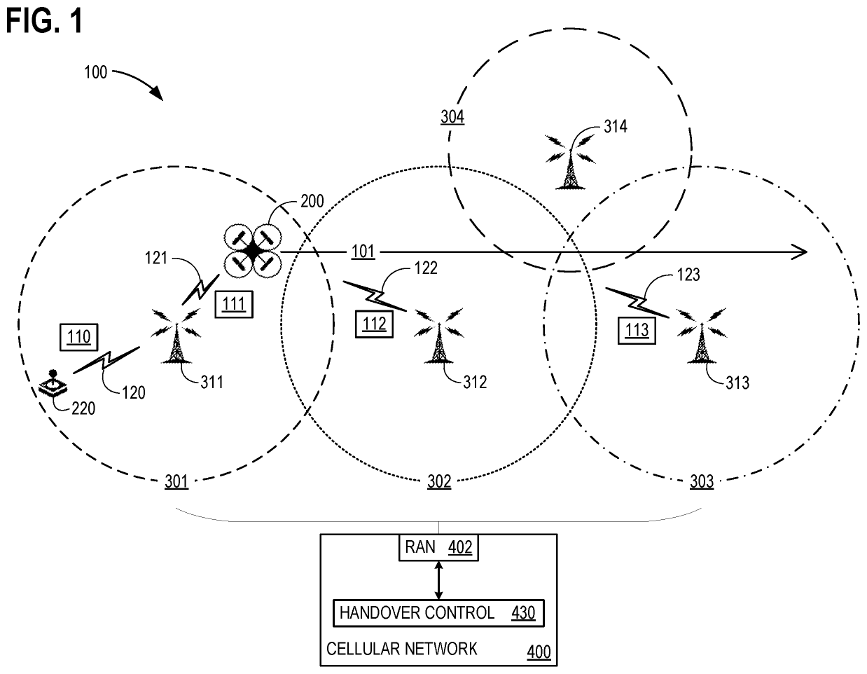

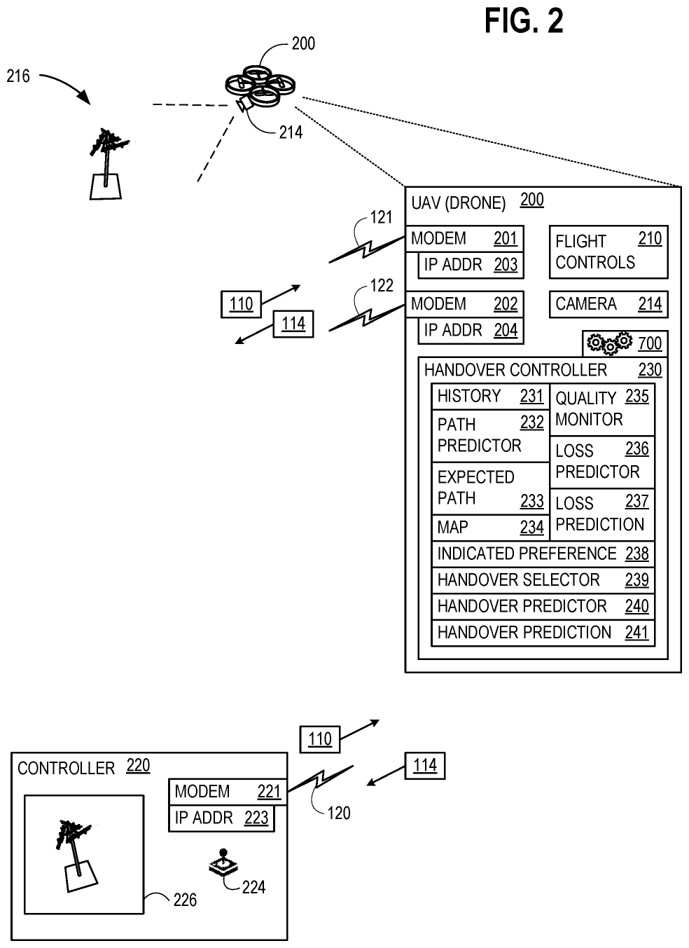

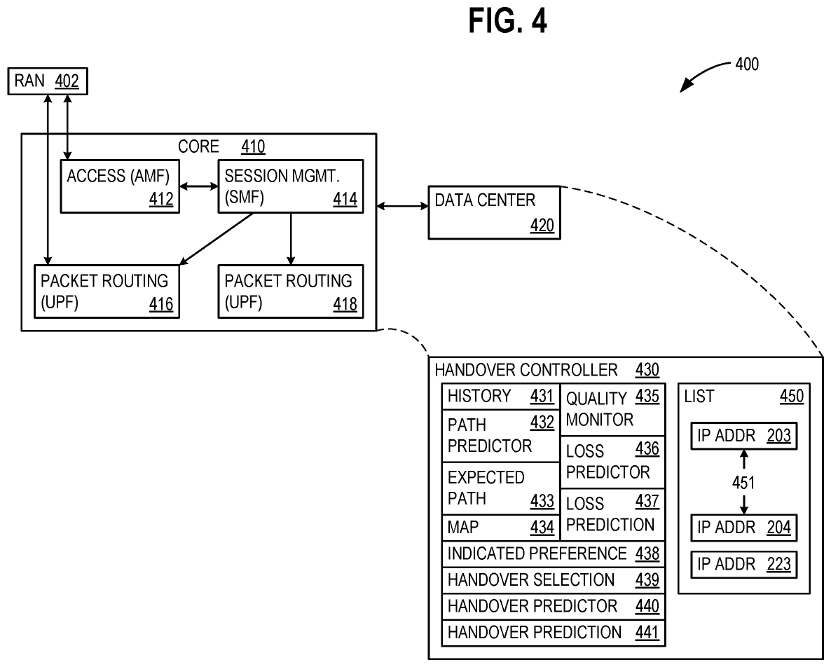

With reference now to the figures, FIG. 1 illustrates an architecture 100 that advantageously provides for pre-termination handover, in order to minimize communication channel disruption. In architecture 100, signals 110 (e.g., command and control and other signals) from a UAV controller 220 going to a mobile device 200, as well as signals 114 (e.g., video and other signals, see FIG. 2) from mobile device 200 going to UAV controller 220 pass through a cellular network 400. Mobile device 200 and UAV controller 220 are shown in further detail in FIG. 2. Cellular network 400 is shown in further detail in FIG. 4.

Mobile device 200 has a transit path 101 (e.g., a flight path for a UAV or other transit path, in the case of a hand-held mobile device in a surface conveyance) through various cells of cellular network: a cell 301, a cell 302, a cell 303, and a cell 304. Cells 301-304, and other cells of cellular network 400, are within a radio access network (RAN) 402 and are each supported by a base station. For 5G examples, the base stations supporting cells 301-304 each comprises a gNodeB (gNB).

A handover controller 430 of cellular network 400 controls the handover of mobile device 200 among the various cells 301-303. In some examples, handover controller 430 of cellular network 400 operates in conjunction with a handover controller 230 of mobile device 200, which is shown in, and described in relation to, FIG. 2.

Over the course of transit path 101, mobile device 200 alternately connects with each of cell 301, cell 302, and cell 303. Cell 301 is based at cell site 311 and connects to mobile device 200 using a connection 111 over an air interface 121. Cell 302 is based at cell site 312 and connects to mobile device 200 using a connection 112 over an air interface 122. Cell 303 is based at cell site 313 and connects to mobile device 200 using a connection 113 over an air interface 123.

Cell 304 is based at cell site 314, but, as shown, will not have a connection with mobile device 200 in this example. This is because transit path 101 will move mobile device 200 into cell 303 before there is a need for a handover away from cell 302. As described below, handover controller 430 (and/or handover controller 230) is able to determine that, since a handover to cell 303 is looming along a predicted transit path of mobile device 200, a handover to cell 304 is unnecessary and inefficient.

UAV controller 220 communicates with cellular network 400 using an air interface 120 in cell 301 to send (transmit) signals 110 to mobile device 200. A hard handover requires 30 ms to 60 ms when the connection setup goes smoothly. Even this may be problematic for command and control of a flying craft. If there is any delay, the resulting interruption could be significantly impactful. However, by leveraging the advantageous aspects of the disclosure, cellular control of UAVs is rendered safer, improving public safety.

FIG. 2 illustrates further detail for mobile device 200 in a UAV configuration, and also for UAV controller 220. As illustrated, mobile device 200 is a UAV with a camera 214 that captures live action video of a cellular tower 216 in the illustrated example, such as may be located as cell site 311. When initially within cell 301, mobile device 200 receives signals 110 from UAV controller 220 via cellular network 400, over connection 111 (of FIG. 1) using air interface 121, and transmits signals 114 to UAV controller 220 via cellular network 400 using the same connection 111.

When mobile device 200 moves into cell 302, mobile device 200 then receives signals 110 from UAV controller 220 over connection 112 using air interface 122, as depicted in FIG. 1, and transmits signals 114 signals to UAV controller 220 using the same connection 112. In some scenarios, when both connection 111 and connection 112 are in place for a brief time, signals 110 may pass over one of connections 111 and 112 while signals 114 use the other connection.

Mobile device 200 has a first cellular modem 201, which has an internet protocol (IP) address 203. In some examples, cellular modem 201 comprises an OFDM cellular modem, and in some examples, cellular modem 201 is configured for 5G standalone architecture (SA). Mobile device 200 also has a second cellular modem 202, which has an IP address 204. In some examples, cellular modem 202 comprises an OFDM cellular modem, and in some examples, cellular modem 202 is also configured for 5G SA. Cellular network 400 uses IP addresses 203 and 204 to route signals 110 to cellular modem 201 and cellular modem 202, respectively. 5G SA is a 5G network architecture that does not rely on a 4G (or any other) network core.

Mobile device 200 actuates flight controls 210 (e.g., rotors and other flight control surfaces) based on the command and control portion of signals 110. Live action video and/or still images captured by camera 214 are transmitted to UAV controller 220 within signals 114.

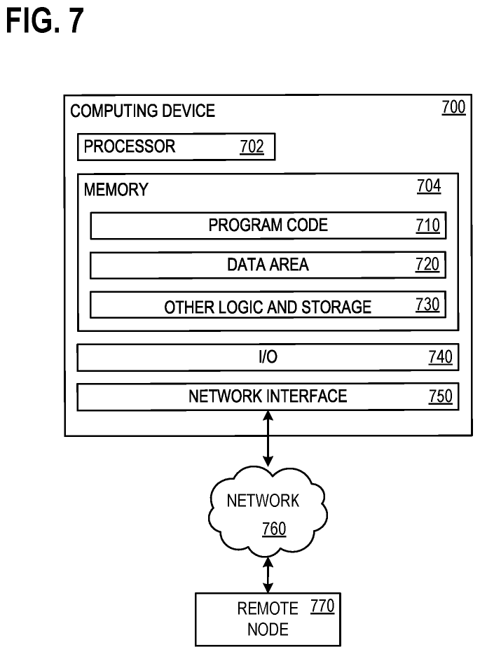

In some examples, mobile device 200 does not have input to the pre-termination handover process and control of the pre-termination handover process is within cellular network 400, or a remote server reached through cellular network 400. However, in some examples, mobile device 200 does have at least some input to the pre-termination handover process described herein, or may even control aspects of the pre-termination handover process, using a handover controller 230 that is stored on and executed by one or more computing devices 700 of FIG. 7, implemented on mobile device 200. In some examples, at least some aspects of handover controller 230 are implemented in one or both of cellular modems 201 and 202.

In some examples, handover controller 230 of mobile device 200 is able to control which frequencies are used, so that cellular modem 201 and cellular modem 202 each use different sets of frequencies, while cellular network 400 controls layer management. In such a scenario, mobile device 200 reports the frequencies available for use and network 400 instructs mobile device 200 which specific one of the reported frequencies to use based on collected signal measurements and policy.

Handover controller 230 maintains a path history 231 of mobile device 200 and/or other mobile devices, which is used by a path predictor 232 to predict an expected path 233 of mobile device 200. In some examples, path predictor 232 includes a machine learning (ML) model. As used herein, ML includes artificial intelligence (AI).

For example, mobile device 200 may by a UAV that is flying a repeated course or a course in a flight plan that is also stored within path history 231. In some scenarios, UAVs may typically remain within certain flight corridors or remain within sight of some item (e.g., electrical transmission line or gas pipeline) for an inspection, and flight path histories of the other UAVs, whether stored individually or condensed into an aggregate flight profile, enable path predictor 232 to predict expected path 233.

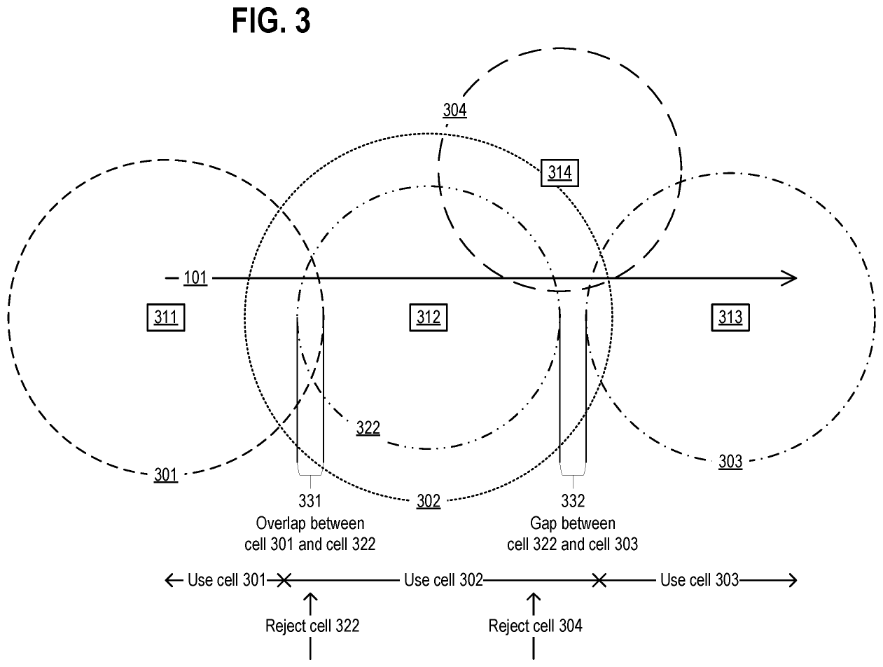

In some examples, handover controller 230 also has a map 234 of cells of cellular network (e.g., cells 301-304, and also cell 322, shown in FIG. 3), along with some coverage information, such as frequency and or expected cell range and direction from a cell site or tower). In some examples, map 234 is loaded from cellular network 400, whereas in some other examples, handover controller 230 builds or supplements map 234 using its own discovery of cells as mobile device 200 passes through the cells.

Combining expected path 233 with map 234 enables a connection loss predictor 236 to generate a loss prediction 237 to alert handover controller of an imminent connection loss. For example, connection loss predictor 236 may generate loss prediction 237 when mobile device 200 nears the edge of cell 301 and expected path 233 passes out of cell 301 into cell 302 (as is shown for transit path 101 in FIGS. 1 and 3).

In some examples, handover controller 230 also has a connection quality monitor 235 that monitors the quality of the current connection, and stores the history. Connection quality monitor 235 may monitor radio frequency (RF) signal parameters, such as signal power parameters, or digital signal parameters, such as errors, error rate, and lost packets. Using results from connection quality monitor 235 also enables connection loss predictor 236 to generate loss prediction 237.

In some examples, connection loss predictor 236 determines that a connection loss is imminent, which is indicated in loss prediction 237, using results from connection quality monitor 235. In some examples, connection loss predictor 236 determines that a connection loss is imminent using expected path 233 with map 234. In some examples, connection loss predictor 236 determines that a connection loss is imminent using both results from connection quality monitor 235 and expected path 233 with map 234. In some examples, connection loss predictor 236 comprises an ML model.

A handover selector 239 uses an indicated preference 238 for a connection parameter to select among multiple handover options, when available. For example, lower cellular frequencies tend to travel further and penetrate better through obstructions, such as foliage, although at the cost of lower data rates. Higher cellular frequencies tend to provide higher data rates at the cost of shorter range and poorer penetration through obstructions. Indicated preference 238 may be set ahead of time, or determined by handover controller 230 using path history 231, expected path 233, and/or options available within map 234. In some examples, handover selector 239 includes an ML model.

A handover predictor 240 predicts imminent handovers as handover prediction 241, using loss prediction 237, map 234, and results from handover selector 239, such as results based on (at least) indicated preference 238. Handover prediction 241 includes not only that a loss is imminent (this is already in loss prediction 237), but further includes the likely next cell. The likely next cell is determined based on at least expected path 233 and indicated preference 238. In some examples, handover predictor 240 includes an ML model. In some examples, at least some aspects of handover controller 230 are implemented in one or both of cellular modems 201 and 202.

UAV controller 220 has a cellular modem 221, which has an IP address 223. In some examples, cellular modem 221 comprises an OFDM cellular modem, and in some examples, cellular modem 221 is configured for 5G SA. Cellular network 400 uses IP address 223 to route signals 114 to cellular modem 221. UAV controller 220 receives signals 114 from mobile device 200 via cellular network 400, using air interface 120, and also transmits signals 110 to mobile device 200 via cellular network 400 using air interface 120.

UAV controller 220 also has flight control actuator 224 that is used to generate at least the command and control portion of signals 110 and a video display 226 that is used to display at least the video portion of signals 114.

FIG. 3 illustrates further detail for the cells of architecture 100. As indicated, transit path 101 passes through all of cells 301-304 and also a cell 322 that is based at cell site 312 and co-located with cell 302. Since cell 322 has a shorter range than cell 302, the situation may be that cell 322 uses a higher frequency than cell 302. As shown, cell 301 and cell 322 overlap in an overlap region 331, and there is a gap 332 between cell 322 and cell 303.

When mobile device 200 is departing from cell 301 along transit path 101, cellular modem 202 is within range of a plurality of cells, specifically cells 302 and 322, to which cellular modem 200 has the option of connecting. However, because indicated preference 238 indicates a lower frequency (in this illustrated example), cell 302 is selected in favor of cell 322. Due to the further usable range of cell 302, a handover from cell 322 to cell 302, to provide connectivity while mobile device 200 is within gap 332, is avoided. Instead, cellular modem 202 is able to remain connected to cell 302 until cellular modem 201 is able to connect to cell 303.

As indicated, three cells are used, cells 301, cell 302, and cell 303. Further cell 322 is rejected, due to indicated preference 238 (or indicated preference 438 of FIG. 4), and cell 304 is also rejected, due to expected path 233 (or expected path 433 of FIG. 4).

FIG. 4 illustrates further detail for cellular network 400. Cellular network 400 has a cellular network core 410 that routes data within RAN 402 and between RAN 402 and a data center 420. Cellular network core 410 performs packet-switching and routing functions for services, including voice calls, text messages, and mobile data. Cellular network core 410 has multiple packet routing nodes, including a packet routing node 416 and another packet routing node 418; access nodes, including an access node 412; and at least one session management node, such as session management node 414. In some examples, for example 5G, packet routing nodes 416 and 418 comprise user plane functions (UPFs); access node 412 comprises an access and mobility function (AMF); and session management node 414 comprises a session management function (SMF).

Handover controller 430 may be located in any of RAN 402, a node of cellular network core 410, or data center 420. Elements 431-441 of handover controller 430 correspond to elements 231-241 of handover controller 230, and have the functionality described above for elements 231-241 of handover controller 230, except as noted below.

In some examples, handover controller 430 and handover controller 230 operate together, with the processing burden shared, and data exchanged, as necessary for collaborative operation. Some examples, however, do not use handover controller 230 and so handover controller 430 manages the pre-termination handovers.

A path history 431 is obtained from mobile device 200 or independently determined by noting the cell connectivity history. That is, whereas path history 231 may have relatively accurate resolution due to navigation information available to mobile device 200 (e.g., GPS coordinates), path history 431 may be significantly more coarse and have only cell-derived location approximations. A path predictor 432 (which may include an ML model) generates an expected path 433, but possibly at a resolution similar to that of path history 431. A map 434 may be more complete and accurate than map 234, because the locations of cell sites and their frequencies is already known to cellular network 400.

A connection quality monitor 435 may measure signal quality of the received signal (e.g., RF signal parameters and/or digital signal parameters) and/or may take input from measurements made by connection quality monitor 235. A connection loss predictor 436 determines that a connection loss is imminent and generates loss prediction 437 in a manner similar to that described for connection loss predictor 236. For example, connection loss predictor 436 may use expected path 433 with map 434, use results from connection quality monitor 435, and/or use both results from connection quality monitor 435 and expected path 433 with map 434. In some examples, connection loss predictor 436 comprises an ML model.

Indicated preference 438 has the information described for indicated preference 238. A handover selector 439 operates similarly to the description of the operation of handover selector 239, and a handover predictor 440 generates a handover prediction 441 similarly to the manner described for handover predictor 240 generating handover prediction 241. In some examples, either or both of handover selector 439 and handover predictor 440 comprises an ML model.

Handover controller 430 has an additional feature beyond those described for handover controller 230. Handover controller 430 has a list 450 of IP addresses, or at least access to list 450 somewhere within cellular network 400. List 450 has IP address 203 for cellular modem 201, IP address 204 for cellular modem 202, and IP address 223 for cellular modem 221. Further, there is a link 451 associating IP address 203 with IP address 204, enabling cellular network 400 (or at least handover controller 430) to identify that IP address 203 and IP address 204 are both associated with the same device, mobile device 200. This enables handover controller 430 to recognize that any loss prediction or handover prediction for one of cellular modems 201 and 202 is valid for the other. This is because cellular modems 201 and 202 travel together.

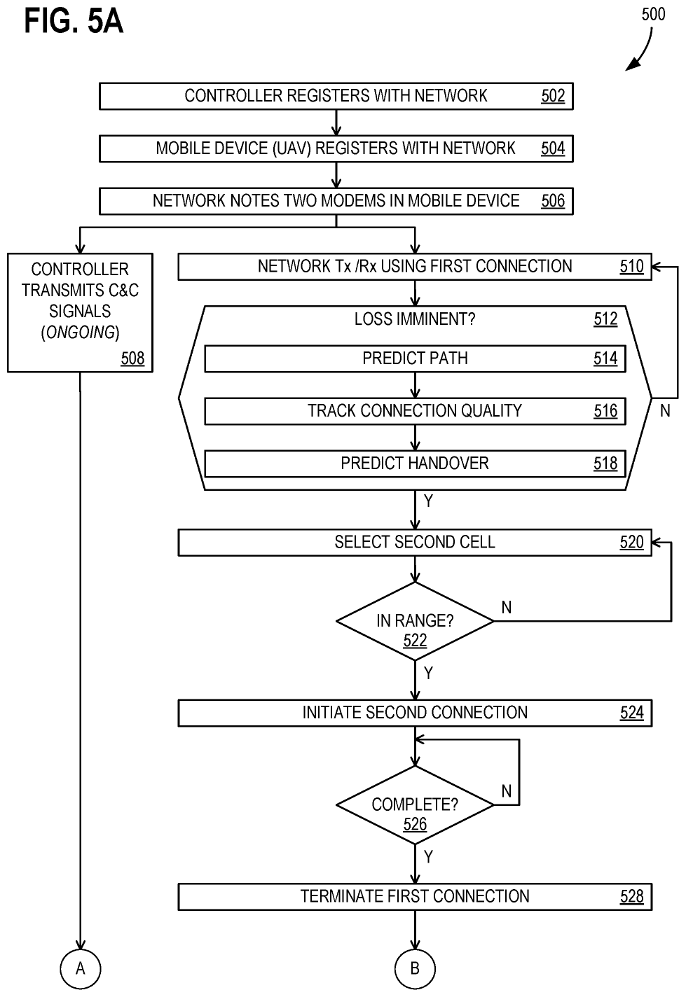

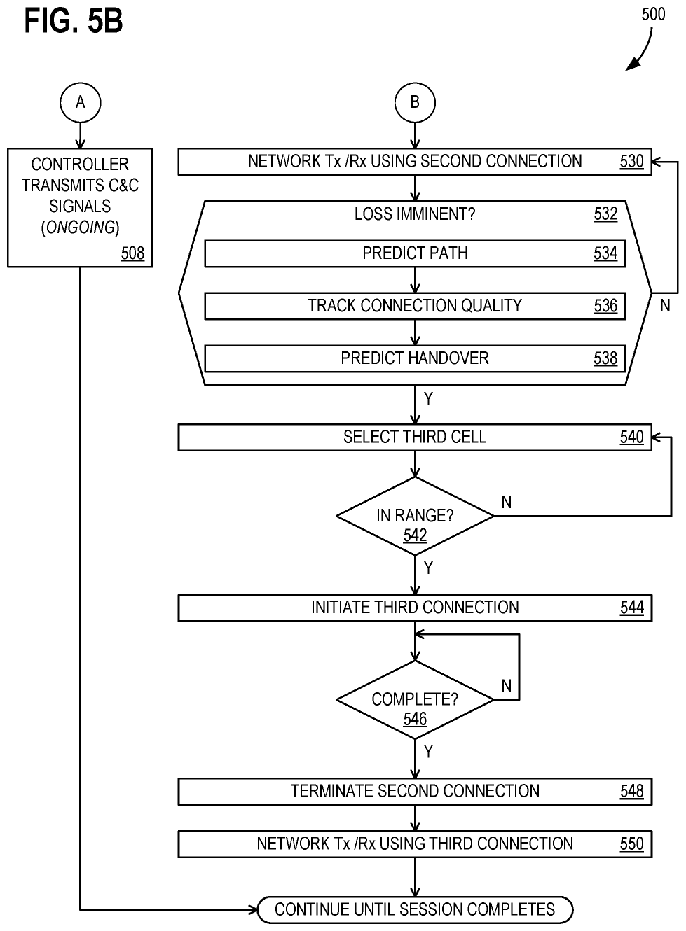

FIGS. 5A and 5B together illustrate a flowchart 500 of exemplary operations associated with examples of architecture 100. In some examples, at least a portion of flowchart 500 is performed using one or more computing devices 700 of FIG. 7.

Referring first to FIG. 5A, flowchart 500 commences with UAV controller 220 registering with cellular network 400 in operation 502. In operation 504, mobile device 200 (e.g., a UAV) registers with cellular network 400. This initial connection 111 between cellular modem 201 of mobile device 200 and cell 301 over air interface 121. In some examples, connection 111 is used for command and control of mobile device 200. Cellular network 400 identifies that cellular modem 201 and cellular modem 202 are both associated with mobile device 200, in operation 506. Cellular modem 201 and cellular modem 202 are OFDM cellular modems, and in some examples, are 5G cellular modems.

In operation 508, UAV controller 220 transmits data (e.g., signals 110, such as command and control signals) over air interface 120. Cellular modem 201 is initially connected to cell 301, and cellular modem 202 is initially not connected to cellular network 400, as operation 508 begins. However, operation 508 occurs in parallel with operations 510-550, and so the connection status of both cellular modems 201 and 202 change during operation 508.

Cellular network 400 transmits data across connection 111 over air interface 121 in operation 510, and decision operation 512 determines whether loss of connection 111 (between cellular modem 201 of mobile device 200 and cell 301 of cellular network 400) is imminent, using one or more of operations 514-518, performed by handover controller 430 and/or 230. That is, in some examples, cellular network 400 determines that loss of a connection is imminent, and in some examples, mobile device 200 determines that loss of a connection is imminent. In some examples, loss of a connection is imminent when the loss is expected within 500 ms.

Operation 514 predicts expected path 433 or 233 of mobile device 200 based on at least path history 431 or 231 of mobile device 200 and/or path histories of other mobile devices. In some examples, an ML model predicts expected path 433 or 233 of mobile device 200. Operation 516 tracks a connection quality of connection 111, which may be a signal power metric, an error metric, or a packet loss metric. Operation 518 predicts an imminent handover of cellular modem 201 from cell 301 to cell 302, which in some examples, is based on at least expected path 433 or 233 of mobile device 200, and/or the signal quality.

If a connection loss is not imminent, flowchart 500 returns to operation 510. Otherwise, decision operation 512 determines that loss of connection 111 is imminent, operation 520 selects cell 302 from among a plurality of cells (e.g., cell 302 and 322), in which mobile device 200 is in range, based on at least indicated preference 438 or 238 for a connection parameter. In some examples, indicated preference 438 or 238 indicates a lower frequency, further cell coverage range, a higher frequency, or a higher data rate.

Decision operation 522 determines whether mobile device 200 is in range to connect to cell 302. If not, flowchart 500 returns to operation 520 to possibly select a different cell. Otherwise, if decision operation determines that mobile device 200 is in range to connect to cell 302, operation 524 initiates connection 112 between cellular modem 202 of mobile device 200 and cell 302 based on at least the determinations that mobile device 200 is in range to connect to cell 302 and that the loss of connection 111 is imminent. In some examples, connection 112 is used for command and control of mobile device 200.

Decision operation 526 determines whether connection 112 is complete. If not, flowchart waits at decision operation 526 until decision operation determines that connection 112 is complete. Operation 528 terminates connection 111 based on at least the determination that connection 112 is complete.

Moving now to FIG. 5B, flowchart 500 continues. Operations 530-548 are similar to operations 510-528, except for moving from connection 112 with cell 302 to connection 113 with cell 303 (rather than the move from connection 111 to connection 112). Operation 508 continues in parallel with operations 530-550.

Cellular network 400 transmits data across connection 112 over air interface 122 in operation 530. Decision operation 532 comprises one or more of operations 534-538 and determines whether loss of connection 112 is imminent. Operation 534 predicts expected path 433 or 233 of mobile device 200. Operation 536 tracks a connection quality of connection 111. Operation 538 predicts an imminent handover of cellular modem 201 from cell 301 to cell 302, which in some examples, is based on at least expected path 433 or 233 of mobile device 200.

If connection loss is not imminent, flowchart 500 returns to operation 530. Otherwise, if decision operation 532 determines that loss of connection 112 is imminent, operation 540 selects cell 303 from among a plurality of cells, in which mobile device 200 is in range, based on at least indicated preference 438 or 238. In some examples, such as if mobile device turned around, cell 303 may be cell 301. Decision operation 542 determines whether mobile device 200 is in range to connect to cell 303, and if not, flowchart 500 returns to operation 540 to possibly select a different cell.

When decision operation 542 determines that mobile device 200 is in range to connect to cell 303, operation 544 initiates connection 113 between cellular modem 201 of mobile device 200 and cell 303, based on at least the determinations that mobile device 200 is in range to connect to cell 303 and that the loss of connection 112 is imminent. In some examples, connection 113 is used for command and control of mobile device 200.

Decision operation 546 determines whether connection 113 is complete, and if not, flowchart 500 waits at decision operation 546. When decision operation 546 determines that connection 113 is complete, operation 548 terminates connection 112 based on at least the determination that connection 113 is complete. Cellular network 400 transmits data across connection 113 over air interface 123 in operation 550.

Flowchart remains ongoing, continuing the pre-termination handover process, following versions of operations 510-528 (and also operations 530-548) for further handovers to other cells, as transit path 101 continues.

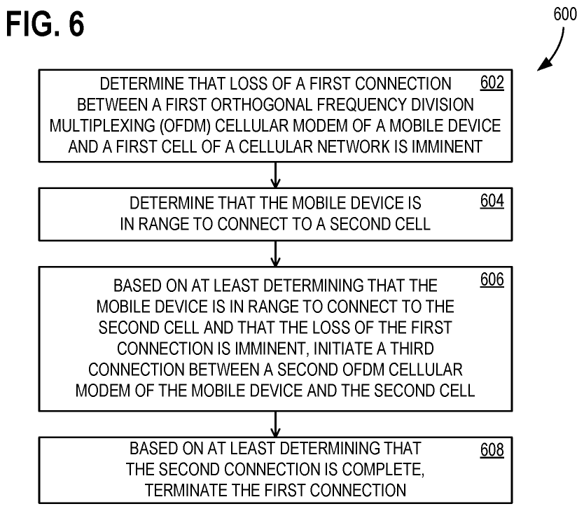

FIG. 6 illustrates a flowchart 600 of exemplary operations associated with examples of architecture 100. In some examples, at least a portion of flowchart 600 may be performed using one or more computing devices 700 of FIG. 7. Flowchart 600 commences with operation 602, which includes determining that loss of a first connection between a first OFDM cellular modem of a mobile device and a first cell of a cellular network is imminent.

Operation 604 includes determining that the mobile device is in range to connect to a second cell. Operation 606 includes, based on at least determining that the mobile device is in range to connect to the second cell and that the loss of the first connection is imminent, initiating a second connection between a second OFDM cellular modem of the mobile device and the second cell. Operation 608 includes, based on at least determining that the second connection is complete, terminating the first connection.

FIG. 7 illustrates a block diagram of computing device 700 that may be used as any component described herein that may require computational or storage capacity. Computing device 700 has at least a processor 702 and a memory 704 that holds program code 710, data area 720, and other logic and storage 730. Memory 704 is any device allowing information, such as computer executable instructions and/or other data, to be stored and retrieved. For example, memory 704 may include one or more random access memory (RAM) modules, flash memory modules, hard disks, solid-state disks, persistent memory devices, and/or optical disks. Program code 710 comprises computer executable instructions and computer executable components including any instructions necessary to perform operations described herein. Data area 720 holds any data necessary to perform operations described herein. Memory 704 also includes other logic and storage 730 that performs or facilitates other functions disclosed herein or otherwise required of computing device 700. An input/output (I/O) component 740 facilitates receiving input from users and other devices and generating displays for users and outputs for other devices. A network interface 750 permits communication over a network 760 with a remote node 770, which may represent another implementation of computing device 700. For example, a remote node 770 may represent another of the above-noted nodes within architecture 100.

### Additional Examples

A method of edge processing comprises: determining that loss of a first connection between a first OFDM cellular modem of a mobile device and a first cell of a cellular network is imminent; determining that the mobile device is in range to connect to a second cell; based on at least determining that the mobile device is in range to connect to the second cell and that the loss of the first connection is imminent, initiating a second connection between a second OFDM cellular modem of the mobile device and the second cell; and based on at least determining that the second connection is complete, terminating the first connection.

A system for edge processing comprises: a processor; and a computer-readable medium storing instructions that are operative upon execution by the processor to: determine that loss of a first connection between a first OFDM cellular modem of a mobile device and a first cell of a cellular network is imminent; determine that the mobile device is in range to connect to a second cell; based on at least determining that the mobile device is in range to connect to the second cell and that the loss of the first connection is imminent, initiate a third connection between a second OFDM cellular modem of the mobile device and the second cell; and based on at least determining that the second connection is complete, terminate the first connection.

One or more example computer storage devices has computer-executable instructions stored thereon, which, upon execution by a computer, cause the computer to perform operations comprising: determining that loss of a first connection between a first OFDM cellular modem of a mobile device and a first cell of a cellular network is imminent, wherein the cellular network identifies that the first cellular modem and a second OFDM cellular modem are both associated with the mobile device, and a wherein a loss of a connection is imminent when expected within 500 ms; determining that the mobile device is in range to connect to a second cell; based on at least determining that the mobile device is in range to connect to the second cell and that the loss of the first connection is imminent, initiating a second connection between the second cellular modem of the mobile device and the second cell; and based on at least determining that the second connection is complete, terminating the first connection, wherein the mobile device comprises a UAV, and wherein the first connection and the second connection are used for command and control of the mobile device.

Alternatively, or in addition to the other examples described herein, examples include any combination of the following:
a loss of a connection is imminent when the loss is expected within 500 ms;
the mobile device comprises a UAV;
the first connection is used for command and control of the mobile device;
the second connection is used for command and control of the mobile device;
determining that loss of the second connection is imminent;
determining that the mobile device is in range to connect to a third cell;
based on at least determining that the mobile device is in range to connect to the third cell, initiating a third connection between the first cellular modem and the third cell;
based on at least determining that the third connection is complete, terminating the second connection;
the third connection is used for command and control of the mobile device;
determining that the loss of the first connection is imminent comprises predicting an expected path of the mobile device;
determining that the loss of the first connection is imminent further comprises predicting, based on at least the expected path of the mobile device, an imminent handover of the first cellular modem from the first cell to the second cell;
selecting the second cell from among a plurality of cells, in which the mobile device is in range, based on at least an indicated preference for a connection parameter;
the indicated preference for a connection parameter comprises a lower frequency;
the cellular network identifies that the first cellular modem and the second cellular modem are both associated with the mobile device;
an ML model determines that loss of a connection is imminent;
an ML model predicts the expected path of the mobile device;
identifying, by the cellular network, that the first cellular modem and the second cellular modem are both associated with the mobile device;
the first cellular modem and the second cellular modem are 5G cellular modems;
the determination that the mobile device is in range to connect to a new cell corresponds to both a determination that the first cellular modem is in range to connect to the new cell and a determination that the second cellular modem is in range to connect to the new cell;
a determination that the first cellular modem is in range to connect to a new cell corresponds to a determination that the second cellular modem is in range to connect to the new cell;
determining that the mobile device is in range to connect to a new cell mobile device comprises determining that the first cellular modem is in range to connect to the new cell;
determining that the mobile device is in range to connect to a new cell mobile device comprises determining that the second cellular modem is in range to connect to the new cell;
the first cellular modem is initially connected to the first cell;
the second cellular modem is initially not connected to a cellular network;
the second cell uses a different frequency than the first cell;
the second cell is within the cellular network of the first cell;
the third cell is within the cellular network of the first cell;
determining whether the second connection is complete;
determining whether the third connection is complete;
transmitting data across the first connection;
transmitting data across the second connection;
transmitting data across the third connection;
the third cell is the first cell;
determining that the loss of the first connection is imminent comprises tracking a connection quality of the first connection;
determining that the loss of the second connection is imminent comprises tracking a connection quality of the second connection;
tracking connection quality comprises tracking at least one metric selected from the list consisting of: a signal power metric, an error metric, and a packet loss metric;
the cellular network determines that loss of a connection is imminent;
the mobile device determines that loss of a connection is imminent;
the second cellular modem determines that the loss of the first connection is imminent;
selecting the third cell from among a plurality of cells, in which the mobile device is in range, based on at least the indicated preference for a connection parameter;
the indicated preference for a connection parameter comprises further cell coverage range;
the indicated preference for a connection parameter comprises a higher data rate;
the indicated preference for a connection parameter comprises a higher frequency;
predicting an expected path of the mobile device based on at least a path history of the mobile device; and
predicting an expected path of the mobile device based on at least path histories of other mobile devices.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of edge processing, the method comprising:
determining that loss of a first connection between a first orthogonal frequency division multiplexing (OFDM) cellular modem of a mobile device and a first cell of a cellular network is imminent;
determining that the mobile device is in range to connect to a second cell;
based on at least determining that the mobile device is in range to connect to the second cell and that the loss of the first connection is imminent, initiating a second connection between a second OFDM cellular modem of the mobile device and the second cell; and
based on at least determining that the second connection is complete, terminating the first connection.

2. The method of claim 1, wherein the mobile device comprises an unmanned aerial vehicle (UAV), and wherein the first connection and the second connection are used for command and control of the mobile device.

3. The method of claim 1, further comprising:
determining that loss of the second connection is imminent;
determining that the mobile device is in range to connect to a third cell;
based on at least determining that the mobile device is in range to connect to the third cell and that the loss of the second connection is imminent, initiating a third connection between the first cellular modem and the third cell; and
based on at least determining that the third connection is complete, terminating the second connection.

4. The method of claim 1, wherein determining that the loss of the first connection is imminent comprises predicting an expected path of the mobile device.

5. The method of claim 4, wherein determining that the loss of the first connection is imminent further comprises predicting, based on at least the expected path of the mobile device, an imminent handover of the first cellular modem from the first cell to the second cell.

6. The method of claim 1, further comprising:
selecting the second cell from among a plurality of cells, in which the mobile device is in range, based on at least an indicated preference for a connection parameter.

7. The method of claim 6, wherein the indicated preference for a connection parameter comprises a lower frequency.

8. The method of claim 1, wherein the cellular network identifies that the first cellular modem and the second cellular modem are both associated with the mobile device.

9. The method of claim 1, wherein a machine learning (ML) model determines that loss of a connection is imminent or predicts an expected path of the mobile device.

10. A system for edge processing, the system comprising:
at processor; and
a computer-readable medium storing instructions that are operative upon execution by the processor to:
determine that loss of a first connection between a first orthogonal frequency division multiplexing (OFDM) cellular modem of a mobile device and a first cell of a cellular network is imminent;
determine that the mobile device is in range to connect to a second cell;
based on at least determining that the mobile device is in range to connect to the second cell and that the loss of the first connection is imminent, initiate a third connection between a second OFDM cellular modem of the mobile device and the second cell; and
based on at least determining that the second connection is complete, terminate the first connection.

11. The system of claim 10, wherein the mobile device comprises an unmanned aerial vehicle (UAV), and wherein the first connection and the second connection are used for command and control of the mobile device.

12. The system of claim 10, wherein the instructions are further operative to:
determine that loss of the second connection is imminent;
determine that the mobile device is in range to connect to a third cell;
based on at least determining that the mobile device is in range to connect to the third cell and that the loss of the second connection is imminent, initiate a third connection between the first cellular modem and the third cell; and
based on at least determining that the third connection is complete, terminate the second connection.

13. The system of claim 10, wherein determining that the loss of the first connection is imminent comprises predicting an expected path of the mobile device.

14. The system of claim 13, wherein determining that the loss of the first connection is imminent further comprises predicting, based on at least an expected path of the mobile device, an imminent handover of the first cellular modem from the first cell to the second cell.

15. The system of claim 10, wherein the instructions are further operative to:
select the second cell from among a plurality of cells, in which the mobile device is in range, based on at least an indicated preference for a lower frequency.

16. One or more computer storage devices having computer-executable instructions stored thereon, which, upon execution by a computer, cause the computer to perform operations comprising:
determining that loss of a first connection between a first orthogonal frequency division multiplexing (OFDM) cellular modem of a mobile device and a first cell of a cellular network is imminent, wherein the cellular network identifies that the first cellular modem and a second OFDM cellular modem are both associated with the mobile device, and a wherein a loss of a connection is imminent when expected within 500 milliseconds (ms);
determining that the mobile device is in range to connect to a second cell;
based on at least determining that the mobile device is in range to connect to the second cell and that the loss of the first connection is imminent, initiating a second connection between the second cellular modem of the mobile device and the second cell; and
based on at least determining that the second connection is complete, terminating the first connection, wherein the mobile device comprises an unmanned aerial vehicle (UAV), and wherein the first connection and the second connection are used for command and control of the mobile device.

17. The one or more computer storage devices of claim 16, wherein the operations further comprise:
determining that loss of the second connection is imminent;
determining that the mobile device is in range to connect to a third cell;
based on at least determining that the mobile device is in range to connect to the third cell and that the loss of the second connection is imminent, initiating a third connection between the first cellular modem and the third cell; and
based on at least determining that the third connection is complete, terminating the second connection.

18. The one or more computer storage devices of claim 16, wherein determining that the loss of the first connection is imminent comprises predicting, based on at least an expected path of the mobile device, an imminent handover of the first cellular modem from the first cell to the second cell.

19. The one or more computer storage devices of claim 16, wherein determining that the loss of the first connection is imminent comprises predicting an expected path of the mobile device based on at least path histories of other mobile devices.

20. The one or more computer storage devices of claim 16, wherein the operations further comprise:
selecting the second cell from among a plurality of cells, in which the mobile device is in range, based on at least an indicated preference for further cell coverage range.
